(19) United States
(12) Patent Application Publication
(10) Pub. No.: US 2026/0202329 A1
(43) Pub. Date: Jul. 16, 2026

(54) MULTI-CHAMBER LASER SENSING USING SPLIT BEAMS

(71) Applicant: Applied Materials, Inc., Santa Clara, CA (US)

(72) Inventor: TIMOTHY CHEN, Los Altos, CA (US)

(21) Appl. No.: 19/019,158

(22) Filed: Jan. 13, 2025

(51) Int. Cl. G01N 21/3504

(52) U.S. Cl. CPC G01N 21/3504; G01N 2201/06113; G01N 2201/08

(57) ABSTRACT

Embodiments described herein relate to an apparatus that includes a laser configured to emit a laser beam, and an optics module optically coupled to the laser. In an embodiment, the optics module includes an optical element configured to split the laser beam into a plurality of split beams. In an embodiment, the apparatus further includes a plurality of optical fibers, where each of the plurality of optical fibers is configured to receive a corresponding one of the plurality of split beams.

### BACKGROUND

### 1) Field

Embodiments relate to the field of laser sensing in a plurality of chambers through the use of a single source laser.

### 2) Description of Related Art

Semiconductor manufacturing use chemical species for many different operations in the manufacturing process flow. For example, chemical species may be used for deposition processes, etching process, treatment processes, or the like. Precise control of chemical species in a plasma and/or gas composition is needed in order to provide the desired process uniformity on the substrate that is being processed and across multiple substrates processed in the facility.

Such properties may be measured with laser-based inspection processes. For example, high sensitivity gas sensing in processing tools may be achieved through the use of mid-infrared to far-infrared laser sources (e.g., absorption spectroscopy). However, these types of laser are significantly more expensive than visible lasers and/or near-infrared lasers. In some instances, the cost of the laser and the associated components (e.g., controllers, power supplies, etc.) may account for a majority of the cost of the sensor module.

In high volume manufacturing (HVM) environments a single tool may comprise multiple chambers, and/or the HVM environment may include multiple tools that each comprise multiple chambers. As such, the cost to integrate high sensitivity gas sensors into the HVM fabrication facility (fab) can become high as the capacity of the fab increases.

### SUMMARY

Embodiments described herein relate to an apparatus that includes a laser configured to emit a laser beam, and an optics module optically coupled to the laser. In an embodiment, the optics module includes an optical element configured to split the laser beam into a plurality of split beams. In an embodiment, the apparatus further includes a plurality of optical fibers, where each of the plurality of optical fibers is configured to receive a corresponding one of the plurality of split beams.

Embodiments described herein relate to a tool that includes a laser configured to emit a primary laser beam and an optics module optically coupled to the laser. In an embodiment, the optics module includes an optical element configured to split the primary laser beam into a plurality of split beams. In an embodiment, the tool further includes a substrate transfer chamber, and a plurality of processing chambers coupled to the substrate transfer chamber. In an embodiment, each processing chamber of the plurality of processing chambers includes an optical fiber configured to receive one of the plurality of split beams. In an embodiment, each of the plurality of split beams is configured to pass through an interior volume of a corresponding one of the plurality processing chambers. In an embodiment, the chambers may also include a detector for receiving the corresponding split beam of the plurality of split beams after the corresponding split beam passes through the interior volume of the corresponding one of the plurality of processing chambers.

Embodiments described herein relate to an apparatus that includes a laser configured to emit a primary beam, where the primary beam has a wavelength between 2 μm and 15 μm. In an embodiment, an optics module is optically coupled to the laser, where the optics module includes an optical element configured to split the primary beam into a plurality of split beams. In an embodiment, the apparatus further includes a plurality of optical fibers, that are each optically coupled to the optics module so that each of the plurality of optical fibers is configured to receive a corresponding one of the plurality of split beams. In an embodiment, the apparatus further includes a plurality of chambers, that are optically coupled to a corresponding one of the plurality of optical fibers.

### BRIEF DESCRIPTION OF THE DRAWINGS

FIG. 1 is a schematic illustration of a tool with a chamber that includes a sensor with a laser that emits a beam through an interior volume of the chamber towards an optical detector, in accordance with an embodiment.

FIG. 2 is a schematic illustration of a cluster tool with a plurality of chambers that each comprise a sensor that senses a beam that is split from a primary beam emitted by a single laser, in accordance with an embodiment.

FIG. 3A is a schematic illustration of an optical splitting system that splits a single laser beam into a plurality of channels with a diffractive optical element, in accordance with an embodiment.

FIG. 3B is a schematic illustration of an optical splitting system that splits a single laser beam into a plurality of channels with a beam splitter, in accordance with an embodiment.

FIG. 3C is a schematic illustration of an optical splitting system that splits a single laser beam into a plurality of channels with an angled optical window that splits the beam in accordance with Fresnel equations, in accordance with an embodiment.

FIG. 3D is a schematic illustration of an optical splitting system that splits a single laser beam into a plurality of channels with a plurality of angled optical windows that split the beam in accordance with Fresnel equations, in accordance with an embodiment.

FIG. 3E is a schematic illustration of an optical splitting system that splits a single laser beam into a plurality of channels with a beam splitter and a retroreflector, in accordance with an embodiment.

FIG. 3F is a schematic illustration of an optical splitting system that splits a single laser beam into a plurality of channels that go towards a plurality of chambers and a refence cell, in accordance with an embodiment.

FIG. 4A is a schematic illustration of a tool that allows for gas absorption spectroscopy on a plurality of chambers with a single laser and a plurality of split beams, in accordance with an embodiment.

FIG. 4B is a schematic illustration of a tool that allows for endpoint detection using interferometry on a plurality of chambers with a single laser and a plurality of split beams, in accordance with an embodiment.

FIG. 4C is a schematic illustration of a tool that allows for laser processing of substrates in a plurality of chambers with a single laser and a plurality of split beams, in accordance with an embodiment.

FIG. 5 is a flow diagram that depicts a process for measuring a property in a plurality of chambers with a sensor system that comprises a single laser and an optical splitting system, in accordance with an embodiment.

FIG. 6 illustrates a block diagram of an exemplary computer system that may be used in conjunction with a processing tool, in accordance with an embodiment.

### DETAILED DESCRIPTION

Embodiments described herein include systems for laser sensing in a plurality of chambers through the use of a single source laser. In the following description, numerous specific details are set forth in order to provide a thorough understanding of embodiments. It will be apparent to one skilled in the art that embodiments may be practiced without these specific details. In other instances, well-known aspects are not described in detail in order to not unnecessarily obscure embodiments. Furthermore, it is to be understood that the various embodiments shown in the accompanying drawings are illustrative representations and are not necessarily drawn to scale.

Various embodiments or aspects of the disclosure are described herein. In some implementations, the different embodiments are practiced separately. However, embodiments are not limited to embodiments being practiced in isolation. For example, two or more different embodiments can be combined together in order to be practiced as a single device, process, structure, or the like. The entirety of various embodiments can be combined together in some instances. In other instances, portions of a first embodiment can be combined with portions of one or more different embodiments. For example, a portion of a first embodiment can be combined with a portion of a second embodiment, or a portion of a first embodiment can be combined with a portion of a second embodiment and a portion of a third embodiment.

The embodiments illustrated and discussed in relation to the figures included herein are provided for the purpose of explaining some of the basic principles of the disclosure. However, the scope of this disclosure covers all related, potential, and/or possible, embodiments, even those differing from the idealized and/or illustrative examples presented. This disclosure covers even those embodiments which incorporate and/or utilize modern, future, and/or as of the time of this writing unknown, components, devices, systems, etc., as replacements for the functionally equivalent, analogous, and/or similar, components, devices, systems, etc., used in the embodiments illustrated and/or discussed herein for the purpose of explanation, illustration, and example.

As noted above, semiconductor manufacturing processes often use chambers, such as plasma chambers. The chambers may rely on precise gas composition and/or plasma properties in order to provide a desired processing outcome on the substrates (e.g., silicon wafers) that are being processed in the chambers. High sensitivity gas sensing (e.g., absorption spectroscopy) may be used in order to provide a measure of a composition of a gas and/or plasma species within the chambers that are being monitored. In order to provide highly accurate readings, mid-infrared (MIR) lasers and/or far-infrared (FIR) lasers may be used. As used herein, MIR lasers may refer lasers that emit electromagnetic radiation with a wavelength of about 2 μm to about 15 μm, and FIR lasers may refer to laser that emit electromagnetic radiation with a wavelength of about 15 μm to about 1,000 μm. While gas absorption spectroscopy is one suitable use of such systems, similar architectures may be used for other chamber monitoring (e.g., end point detection through interferometry). Similar architectures may also be used for laser processing across multiple chambers. For example, laser annealing of substrates may be implemented by laser systems such as those described herein.

As noted above, such MIR lasers and FIR laser (and their associated components (e.g., controllers, power sources, etc.)) are expensive. In a high volume manufacturing (HVM) environment a plurality of chambers need to be monitored at the same time. In some embodiments, the plurality of chambers may be chambers coupled together as part of a single tool. In other embodiments, the plurality of chambers may be part of different tools within the same fabrication facility (fab). Due to the large number of chambers, the cost of implementing such sensors becomes expensive.

Existing optical splitting uses fiber splitters to split an optical beam from a first fiber to a plurality of different fiber channels. That is, the optical splitting occurs within the fibers. Typically, these split channels serve as references or probe the same system from multiple angles rather than provide sensing for different chambers and/or systems. Additionally, fiber splitter technologies that are currently available are not compatible with MIR wavelengths and/or FIR wavelengths.

Accordingly, embodiments disclosed herein comprise a laser-based sensor system for a plurality chambers that comprises a single laser with an optics module that comprises one or more optical elements that allow for a primary beam from the single laser to be split into a plurality of channels (e.g., split beams). Each of the channels may be fed to a corresponding one of the plurality of chambers in order to provide laser sensing within each of the plurality of chambers. In this way, the high cost of a single laser may be split between the plurality of chambers. This allows for a cost-effective laser sensing solution for an HVM fab environment. Further, the optical splitting occurs before the split beams enter the optical fibers.

In an embodiment, the optical elements may include one or more of a beam splitter (e.g., a 50:50 beam splitter), a lens, an optical window that is angled to split the beam in accordance with Fresnel equations, a retroreflector, a mirror, or the like. In an embodiment, the primary beam may be polarized. The polarization may be used in conjunction with the optical window to provide a controlled split of the primary beams into the different channels. In an embodiment, the split beams of each channel may be optically coupled to an optical fiber (e.g., with a fiber collimator), and each of the optical fibers may be coupled to a different one of the chambers. In an embodiment, the split beam leaves the optical fiber, passes through an interior volume of the chamber, and is detected by an optical detector (e.g., a photovoltaic infrared detector, a thermal imaging camera, a complimentary metal-oxide-semiconductor (CMOS) detector, a charge-coupled device (CCD) detector, etc.).

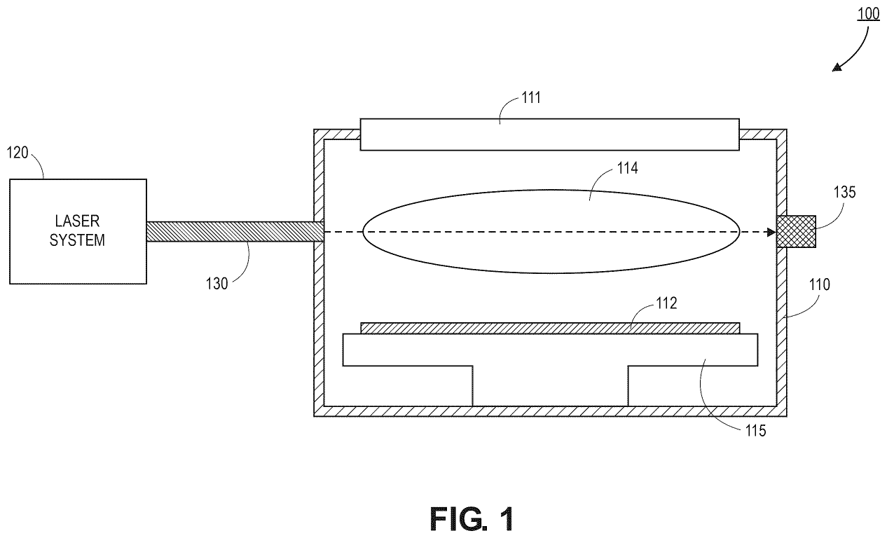

Referring now to FIG. 1, a schematic illustration of a tool 100 is shown, in accordance with an embodiment. In an embodiment, the tool 100 may comprise a chamber 110. A lid 111 may seal a portion of the chamber 110. For example, the lid 111 may include gas passages in order to introduce one or more processing gasses into an interior volume of the chamber 110. The lid 111 may also be coupled to power source (e.g., an RF source or the like) in order to coupled power into gasses within the chamber 110 in order to form a plasma 114.

The chamber 110 may be used to process a substrate 112 that is provided within an interior volume of the chamber 110. For example, the substrate 112 may be supported on a pedestal 115, a chuck (e.g., an electrostatic chuck (ESC)), or the like. The substrate 112 may be any type of substrate 112, such as a semiconductor wafer, a panel (e.g., a glass panel, a package substrate panel used to form package substrates, circuit boards, etc.), or the like.

In an embodiment, the chamber 110 may be a plasma chamber suitable for supporting a plasma 114 within an interior volume of the chamber 110. The plasma 114 may be used to deposit a layer on the substrate 112, etch a layer on the substrate 112, treat a layer on the substrate 112, or the like. While a plasma 114 is shown in FIG. 1, embodiments may also include chambers 110 that do not support the formation of a plasma 114. For example, the chamber 110 may be an annealing chamber, a treatment chamber, a chemical vapor deposition (CVD) chamber, an atomic layer deposition (ALD) chamber, or the like.

In an embodiment, a laser-based sensor system may be used to monitor one or more properties or conditions within an interior volume of the chamber 110. For example, the laser-based sensor system may be used to implement absorption spectroscopy or the like. In the illustrated embodiment, a laser system 120 may be optically coupled to the chamber 110 by an optical cable 130 or the like. The laser system 120 may emit a laser beam (indicated by the dashed line) that passes through an interior volume of the chamber 110, and the laser beam may be received by a detector 135 after the laser beam passes through an interior volume of the chamber 110.

In an embodiment, the laser beam may interact with species within the chamber (e.g., species from the plasma 114, species from a gas in the chamber 110, or the like). The interaction with the species results in an amount of absorption of the laser beam. The change in intensity of the laser beam (as detected by the detector 135) can be correlated to a concentration of a particular species within the chamber 110. In an embodiment, the detector 135 may be any suitable type of optical sensor. For example, the detector 135 may be a photovoltaic infrared detector, thermal imaging camera, CCD sensor, a CMOS sensor or the like. In order to provide high sensitivity, the laser system 120 may comprise an MIR laser or an FIR laser.

While gas absorption spectroscopy is one suitable use of such systems, similar architectures may be used for other chamber monitoring (e.g., end point detection through interferometry). Similar architectures may also be used for laser processing across multiple chambers. For example, laser annealing of substrates may be implemented by laser systems such as those described herein.

As can be appreciated, the number of laser systems 120 may need to match the number of chambers 110 when such a configuration is used for the laser-based sensing system. Due to the high cost of such MIR lasers and FIR lasers, a laser-based system such as the one in FIG. 1 may not be feasible for HVM fabs.

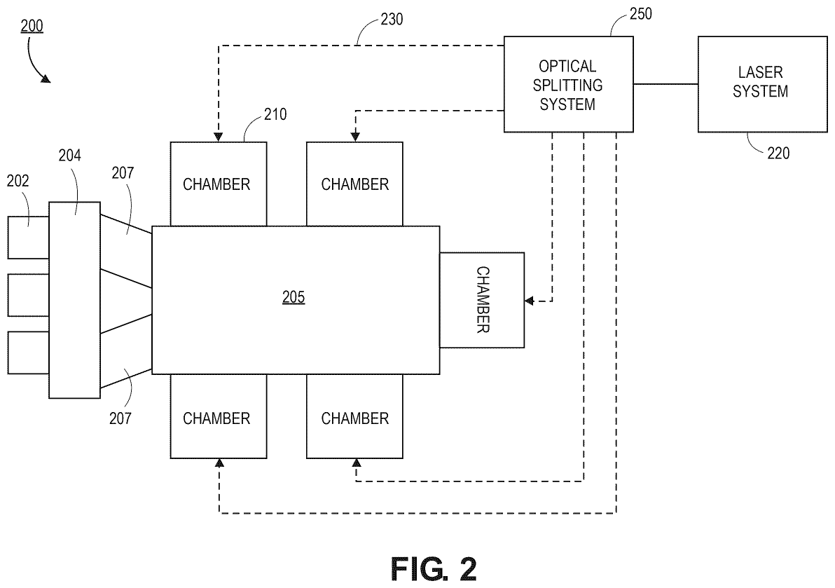

Referring now to FIG. 2, a schematic illustration of a tool 200 with a plurality of chambers 210 that are monitored with a laser-based sensor system with a single laser system 220 that emits a primary beam that is split into a plurality of channels that are each coupled to a different one of the chambers 210 is shown, in accordance with an embodiment.

In an embodiment, the tool 200 may sometimes be referred to as a cluster tool 200. For example, a plurality of chambers 210 may be coupled to a substrate transfer chamber 205. The substrate transfer chamber 205 may include a robot (not shown) that is configured to distribute substrates between the plurality of chambers 210. The transfer chamber 205 may be a low pressure (e.g., vacuum pressure) chamber so that the chambers 210 may remain at sub-atmospheric pressure as the substrates are inserted and/or removed from the chambers 210. The chambers 210 may be any suitable type of chamber for semiconductor processing, such as a plasma chamber, an annealing chamber, a CVD chamber, an ALD chamber, or the like. The chambers 210 may be similar to the chamber 110 described in greater detail above.

In an embodiment, an equipment front end module (EFEM) 204 may be coupled to the substrate transfer chamber 205 by one or more load locks 207. The EFEM 204 may be an interface that receives one or more substrate carriers 202 (e.g., a front opening unified pod (FOUP)) that are capable of storing a plurality of substrates. A robot in the EFEM 204 retrieves substrates from the substrate carrier 202 and transfers the substrate to the load lock 207. The load lock 207 may provide a way to transfer the substrates from an atmospheric pressure environment (e.g., within the EFEM 204) to a sub-atmospheric pressure environment (e.g., within the substrate transfer chamber 205).

As shown, the tool 200 may comprise a laser-based sensing system. The laser-based sensing system may comprise a single laser system 220 that produces a primary laser beam. The primary laser beam may be split into a plurality of channels 230 by an optical splitting system 250. For example, the primary laser beam in FIG. 2 is split into five different channels 230 (e.g., one channel 230 for each of the chambers 210). The optical splitting system 250 may comprise one or more optical elements and/or components capable of splitting the primary laser beam before the primary laser beam enters the fiber optic cables that are coupled to the chambers 210. For example, the optical splitting system may include optical elements that allow for beam splitting based on diffractive elements, Fresnel equations, beam splitters, and/or the like.

In an embodiment, the laser system 220 may comprise the laser and any associated components, such as a controller, a power source, and/or the like. The laser of the laser system 220 may be an MIR laser or an FIR laser. Though, in other embodiments the laser system 220 may comprise a laser that emits a laser beam with any suitable wavelength. As can be appreciated, the high cost of the laser system 220 may be split between the plurality of chambers 210 of the tool 200. As such, the cost per chamber for implementing a laser-based sensing system is significantly reduced compared to having a one-to-one relationship between a number of laser systems 220 and a number of chambers 210.

In the illustrated embodiment, all of the chambers 210 are coupled to the same tool 200. However, embodiments are not limited to such configurations. For example, the chambers 210 may be provided on different tools 200, or the chambers 210 that are coupled to the laser system 220 may be stand-alone chambers 210. That is, one or more chambers 210 may not be part of a larger cluster tool. As will be described in greater detail herein, the use of optical fiber cabling after the optical splitting system 250 allows for a high degree of flexibility in routing the split beams of each channel throughout a fab to provide access to many different tools and/or chambers throughout the fab.

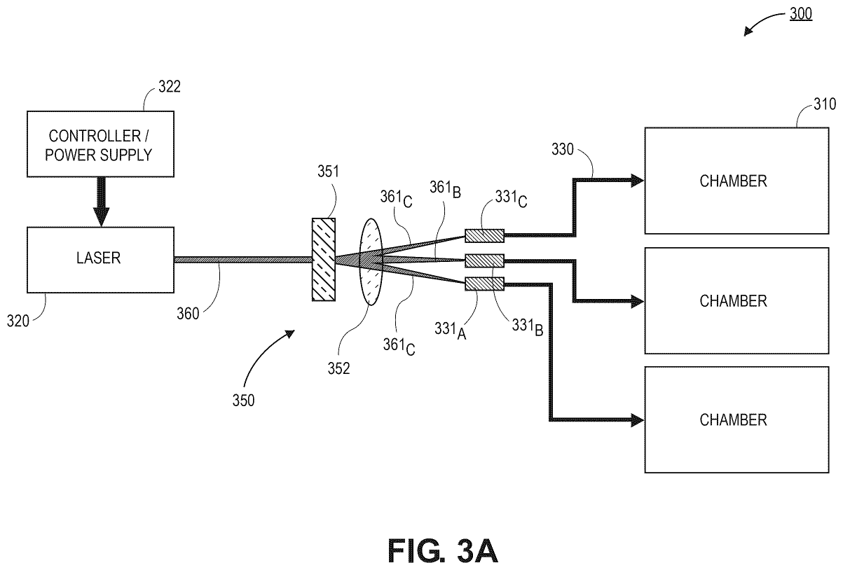

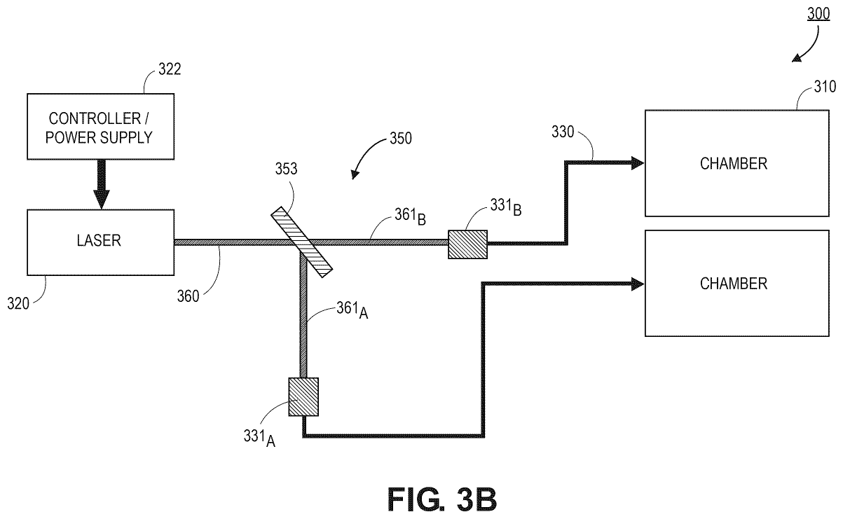

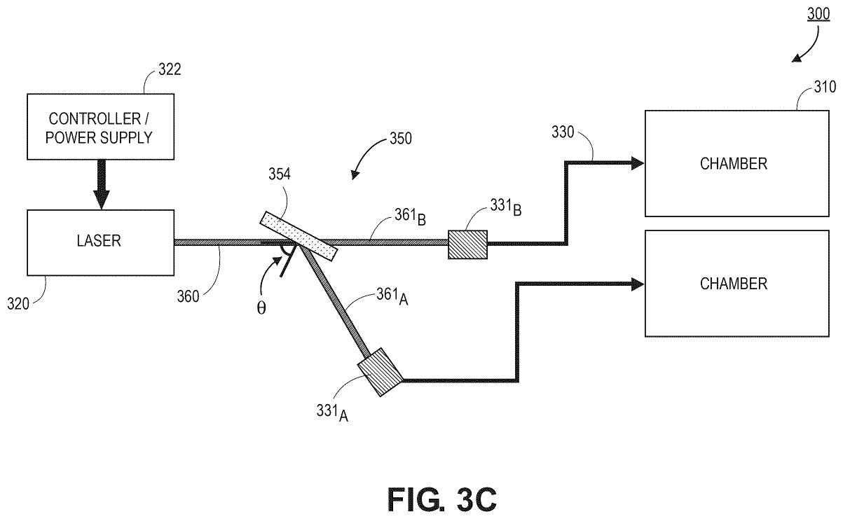

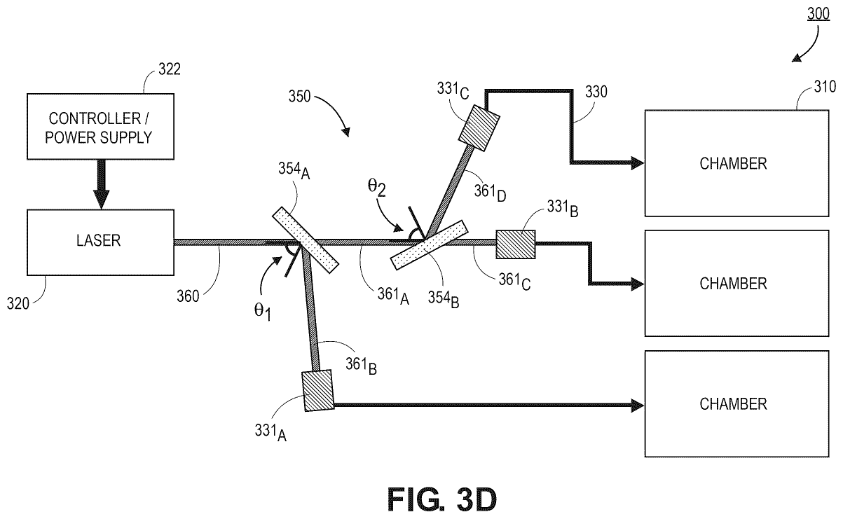

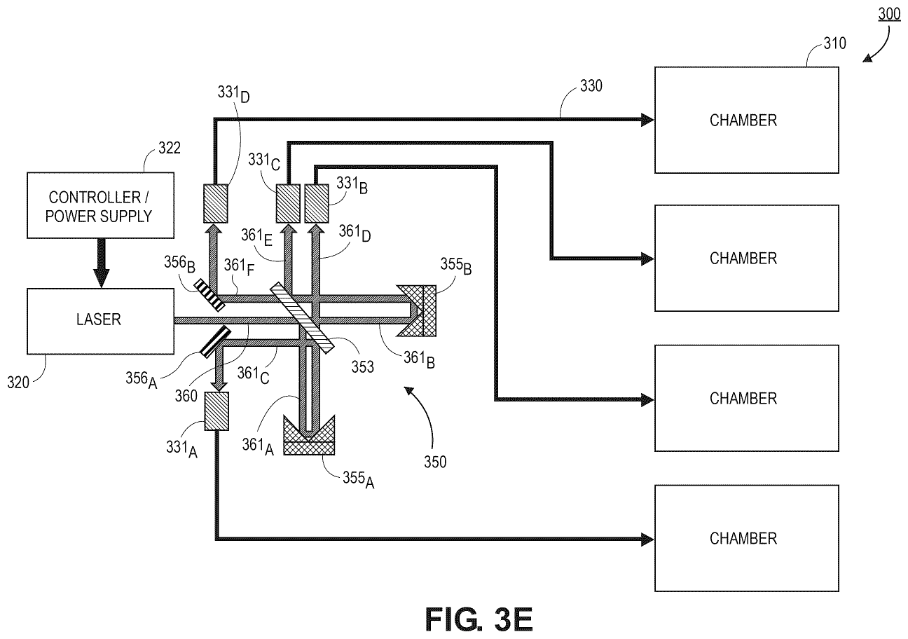

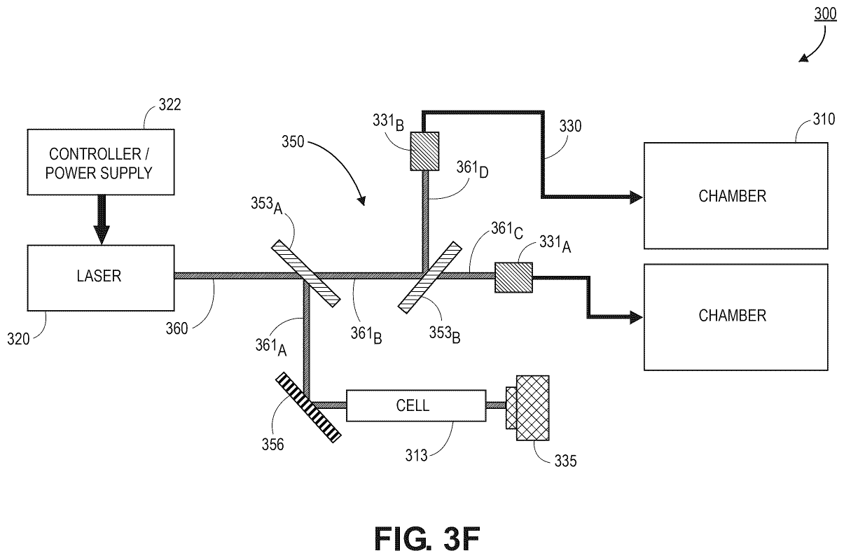

Referring now to FIGS. 3A-3F, a series of schematic illustrations depicting various tools 300 that implement optical splitting systems (which may be referred to as optics modules 350) with different architectures is shown, in accordance with various embodiments. In the illustrated embodiment, an exemplary number of beam splits are shown for each tool 300. Though, it is to be appreciated that multiple instances of the optics module 350 within a tool 300 may allow for additional channels 330 to be provided from the primary beam 360. Further, two or more different optics module 350 architectures described herein may be combined for use within a single tool 300 in some embodiments.

Referring now to FIG. 3A, a schematic illustration of a tool 300 is shown, in accordance with an embodiment. In an embodiment, the tool 300 may comprise a plurality of chambers 310. In an embodiment, each of the chambers 310 may be optically coupled to the same laser 320 in order to implement laser-based sensing within the chamber 310 (e.g., similar to any of the laser-based sensing described in greater detail herein). In a particular embodiment, a ratio of a number of chambers 310 to a number of lasers 320 may be 2:1 or greater, 3:1 or greater, 4:1 or greater, or 10:1 or greater. In the particular embodiment shown in FIG. 3A, the ratio is 3:1.

In an embodiment, the chambers 310 may be similar to any of the chambers described in greater detail herein. For example, the chambers 310 may be sub-atmospheric pressure chambers 310 suitable for supporting a plasma. In the illustrated embodiment, the chambers 310 are shown as stand-alone chambers 310. Though, two or more of the chambers 310 may be coupled to a single cluster tool (e.g., similar to the embodiment shown in FIG. 2).

In an embodiment, the laser 320 may be an MIR laser or an FIR laser. The laser 320 may be similar to any of the lasers described in greater detail herein. The laser 320 may be coupled to supporting components 322, such as a controller, a power supply, a heatsink, and/or the like. In an embodiment, the laser 320 is configured to emit a primary beam 360. The laser 320 may be optically coupled to an optics module 350.

As used herein, “optically coupled” may refer to features (e.g., components, systems, modules, elements, or the like) that are configured so that a laser beam may be emitted from a first feature and received by a second feature. In some embodiments, the optical coupling may rely on an orientation of the optically coupled features so that a laser beam emitted by the first feature is propagated in free space to the second feature (e.g., in a straight line). In other embodiments, optical coupling may include the use of one or more intervening features to direct the laser beam from the first feature to the second feature. For example, intervening features may comprise one or more of an optical fiber, a mirror, a lens, a window, a grating, or the like. More generally, optically coupling two features together may refer to the ability for a laser beam to pass from a first feature to a second feature through any desired path (or paths).

In the illustrated embodiment, the optics module 350 may rely on a diffractive optical element (DOE) 351 to split the primary beam 360 into a plurality of split beams 361. The DOE 351 may be any suitable beam splitting component that relies on diffraction to split the primary beam 360 into a desired number of split beams 361. For example, the DOE 351 in FIG. 3A splits the primary beam 360 into three split beams 361_{A}, 361_{B}, and 361_{C}. Each split beam 361 may be optically coupled into a different channel 330 that is optically coupled to a corresponding one of the plurality of chambers 310. In an embodiment, the channels 330 may be directed to the corresponding chamber 310 through the use of an optical cable. In some embodiments, a fiber collimator 331 may be provided at an end of each optical fiber of the channel 330 in order to improve optical coupling efficiency. For example, split beam 361_{A} is optically coupled to fiber collimator 331_{A}, split beam 361_{B} is optically coupled to fiber collimator 331_{B}, and split beam 361_{C} is optically coupled to fiber collimator 331_{C}. In some embodiments, a lens 352 and/or any other optical elements for focusing and/or controlling a path of the split beams 361 may be used to improve optical coupling efficiency into each of the plurality of channels 330.

Referring now to FIG. 3B, a schematic illustration of a tool 300 is shown, in accordance with an additional embodiment. In an embodiment, the tool 300 in FIG. 3B may be similar to the tool 300 in FIG. 3A, with the exception of the optics module 350 and the number of chambers 310. Instead of using a DOE 351, the optics module 350 in FIG. 3B uses a beam splitter 353. In an embodiment, the beam splitter 353 may be a 50:50 beam splitter. That is, the intensity of the primary beam 360 may be evenly split between a first split beam 361_{A} and a second split beam 361_{B}. As shown, the first split beam 361_{A} is optically coupled into an optical fiber of a first channel 330 through a first fiber collimator 331_{A}, and the second split beam 361_{B} is optically coupled into an optical fiber of a second channel 330 through a second fiber collimator 331_{B}.

Referring now to FIG. 3C, a schematic illustration of a tool 300 is shown, in accordance with an additional embodiment. In an embodiment, the tool 300 in FIG. 3C may be similar to the tool 300 in FIG. 3B, with the exception of the optics module 350. Instead of using a beam splitter 353, an optical window 354 may be used to split the primary beam 360 into a first split beam 361_{A} and a second split beam 361_{B}. The optical window 354 may be angled with respect to a propagation direction of the primary beam 360 in order to provide a substantially even split of the intensity of the primary beam 360 into the first split beam 361_{A} and the second split beam 361_{B}. In an embodiment, the primary beam 360 may also be polarized to take advantage of the optical properties of the optical window 354 in order to split the primary beam 360. For example, the primary beam 360 may be s-polarized. In an embodiment, the angle θ of the optical window 354 may be set based on Fresnel equations. For example, when the optical window 354 comprises sapphire, the angle θ may be about 63° in order to provide a 50-50 split of the intensity between the first split beam 361_{A} and the second split beam 361_{B}.

Referring now to FIG. 3D, a schematic illustration of a tool 300 is shown, in accordance with an additional embodiment. In an embodiment, the tool 300 in FIG. 3D may be similar to the tool 300 in FIG. 3C, with the exception of the optics module 350. Instead of a single optical window 354, a plurality of optical windows 354 are used to provide additional splitting of the primary beam 360 to provide additional channels 330 to support additional chambers 310.

When multiple optical windows 354 are used, the angles need to be chosen in order to provide even intensity distribution between the different channels 330. For example, the first optical window 354_{A} may have a first angle θ₁ that produces a first split beam 361_{A} that has approximately 67% of the intensity of the primary beam 360, and a second split beam 361_{B} has approximately 33% of the intensity of the primary beam 360. In the case of an s-polarized primary beam 360 and a sapphire first optical window 354_{A} the first angle θ₁ may be about 52.5°.

In an embodiment, the first split beam 361_{A} continues to a second optical window 354_{B} that provides an additional split into a third split beam 361_{C} and a fourth split beam 361_{D}. The second optical window 354_{B} may provide an intensity split that provides the third split beam 361_{C} and the fourth split beam 361_{D} with about 33% of the intensity of the primary beam 360 (or about half of the intensity of the first split beam 361_{A}). In the case of an s-polarized primary beam 360 and a sapphire second optical window 354_{B} the second angle θ₂ may be about 63°.

Accordingly, the optics module 350 provides a three-way split of the primary beam 360. A second split beam 361_{B} may be optically coupled into an optical fiber of a channel 330 through a first fiber collimator 331_{A}, a third split beam 361_{C} may be optically coupled into an optical fiber of a channel 330 through a second fiber collimator 331_{B}, and a fourth split beam 361_{D} may be optically coupled into an optical fiber of a channel 330 through a third fiber collimator 331_{C}. As can be appreciated, the use of a plurality of optical mirrors in series and at different angles can be used to generate any number of channels 310 to accommodate a corresponding number of chambers 310.

Further, while the first optical window 354_{A} and the second optical window 354_{B} are both described as being sapphire in FIG. 3D, an optics module 350 may comprise optical windows 354 with different materials. For example, the first optical window 354_{A} may comprise sapphire and the second optical window 354_{B} may comprise zinc selenide. In such an embodiment, a substantially even split of the intensities between three split beams 361 may be obtained when the first angle θ₁ of the first optical window 354_{A} is about 52.5°, and the second angle θ₂ of the second optical window 354_{B} is about 38°.

Referring now to FIG. 3E, a schematic illustration of a tool 300 is shown, in accordance with an additional embodiment. In an embodiment, the tool 300 in FIG. 3E may be similar to the tool 300 in FIG. 3B, with the exception of the optics module 350. Instead of splitting the primary beam 360 into a pair of split beams 361, retroreflectors 355 may be used to split the primary beam 360 into four split beams 361. The retroreflectors 355 may enable the split of the primary beam 360 more than once with only a single beam splitter 353. For example, in FIG. 3E the primary beam 360 is split into a first split beam 361_{A} and a second split beam 361_{B} when passing through the beam splitter 353 a first time. The first split beam 361_{A} and the second split beam 361_{B} are then redirected back to the beam splitter 353 by the retroreflectors 355_{A} and 355_{B}, respectively. This produces a third split beam 361_{C} and a fourth split beam 361_{D} from the first split beam 361_{A}, and a fifth split beam 361_{E} and a sixth split beam 361_{F} from the second split beam 361_{B}.

In an embodiment, the third split beam 361_{C} may be optically coupled into an optical fiber of a channel 330 through a first fiber collimator 331_{A}. As shown, a first mirror 356_{A} may be used to redirect the third split beam 361_{C} to provide a simpler layout for the optics module 350. In an embodiment, the fourth split beam 361_{D} may be optically coupled into an optical fiber of a channel 330 through a second fiber collimator 331_{B}. In an embodiment, the fifth split beam 361_{E} may be optically coupled into an optical fiber of a channel 330 through a third fiber collimator 331_{C}. In an embodiment, the sixth split beam 361_{F} may be optically coupled into an optical fiber of a channel 330 through a fourth fiber collimator 331_{D}. As shown, a second mirror 356_{B} may be used to redirect the sixth split beam 361_{F} to provide a simpler layout for the optics module 350.

Referring now to FIG. 3F, a schematic illustration of a tool 300 is shown, in accordance with an additional embodiment. In an embodiment, the tool 300 in FIG. 3F may be similar to the tool 300 in FIG. 3D, with the exception of the optics module 350. Instead of splitting the primary beam 360 into three channels 330 for three chambers 310, one of the channels may be directed to a reference cell 313. In a particular embodiment, the primary beam 360 may initially be split by a first beam splitter 353_{A} to divert a first split beam 361_{A} to a reference cell 313. For example, the path of the first split beam 361_{A} may be modified by one or more mirrors 356 or the like. While not shown, an optical fiber (and fiber collimator) may also be used to optically couple the optics module 350 to the reference cell 313.

In an embodiment, the first split beam 361_{A} may pass through the reference cell 313 and be detected by a detector 335. The reference cell 313 may comprise a known composition of gas or other species. The intensity drop of the first split beam 361_{A} after passing through the reference cell 313 can be used as a reference for the measurements of the other laser-based sensing systems of the chambers 310 based on the results determined by the detector 335. In an embodiment, the detector 335 may be similar to any of the detectors described in greater detail herein.

In FIG. 3F, a first beam splitter 353_{A} is used to split the primary beam into a first split beam 361_{A} and a second split beam 361_{B}. Though, in other embodiments, an optical window may be used. By controlling an angle and/or material of the optical window, a desired percentage of the intensity of the primary beam 360 may be diverted to the reference cell 313 through the first split beam 361_{A}. This may be beneficial, since the reference cell 313 may not require the same intensity that is used for the laser-based sensing at the chambers 310.

In an embodiment, the second split beam 361_{B} may continue to a second beam splitter 353_{B}. The second beam splitter 353_{B} may split the second split beam 361_{B} into a third split beam 361_{C} and a fourth split beam 361_{D}. The third split beam 361_{C} may be optically coupled to an optical fiber of a channel 330 through a first fiber collimator 331_{A}, and the fourth split beam 361_{D} may be optically coupled to an optical fiber of a channel 330 through a second fiber collimator 331_{B}.

In the embodiments described above with respect to FIGS. 3A-3F, the split beams 361 are each described as having substantially uniform intensities. That is, each of the channels 330 are fed split beams 361 that are substantially uniform to each other. In other embodiments, the split beams 361 may have non-uniform intensities. For example, different chambers 310 may require different intensities of the split beam 361 in order to provide the desired laser-based sensing. This may be due to any reason, such as one or more of the chambers 310 being different from other chambers 310, one or more of the chambers 310 running different process recipes than other chambers 310, one or more of the chambers 310 running different laser-based sensing than other chambers.

The channels 330 may also have non-uniform lengths between the optics module 350 and the corresponding chamber 310. As such, the split beams 361 may experience different amounts of attenuation before reaching the corresponding chamber 310. If a uniform intensity is desired at the chamber 310, the longer channels 330 may be fed a split beam 360 with a higher intensity relative to the intensity of a split beam 360 fed to shorter channels 330 to account for different amounts of attenuation along the channel.

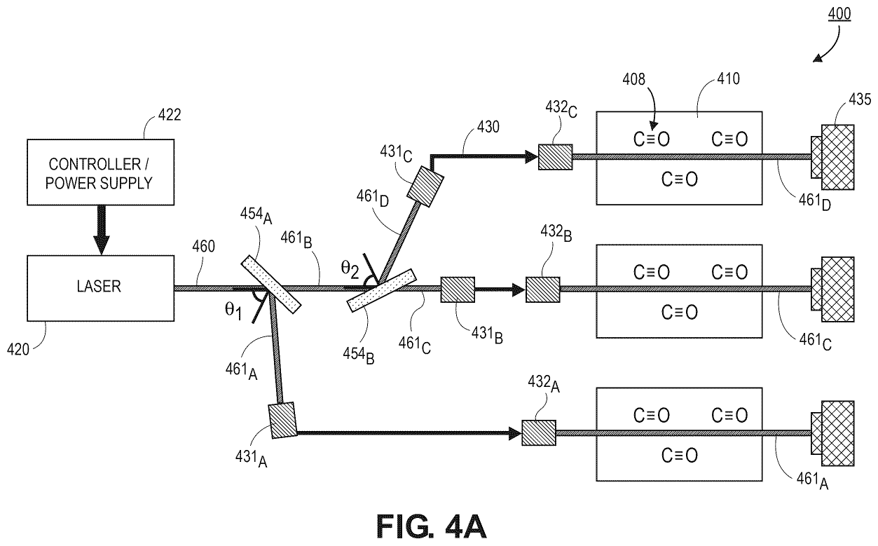

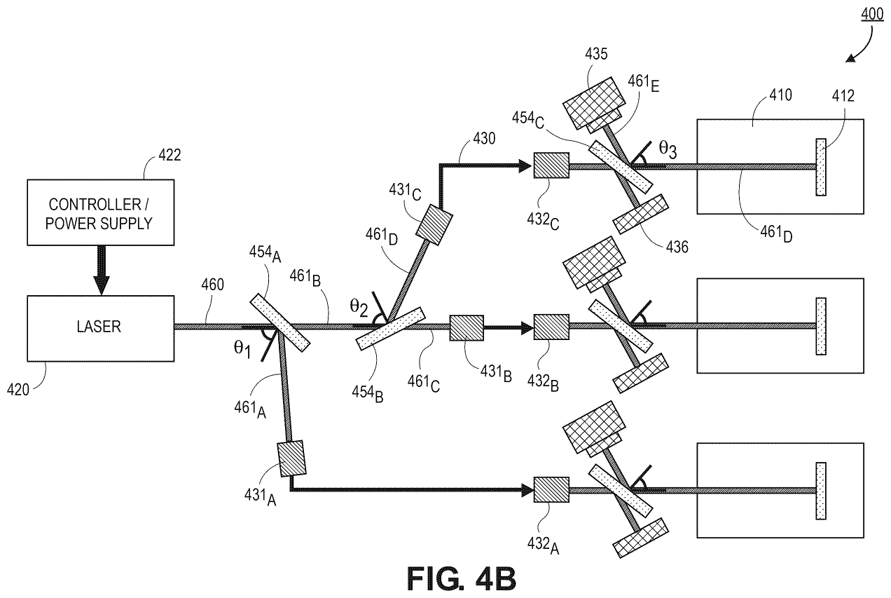

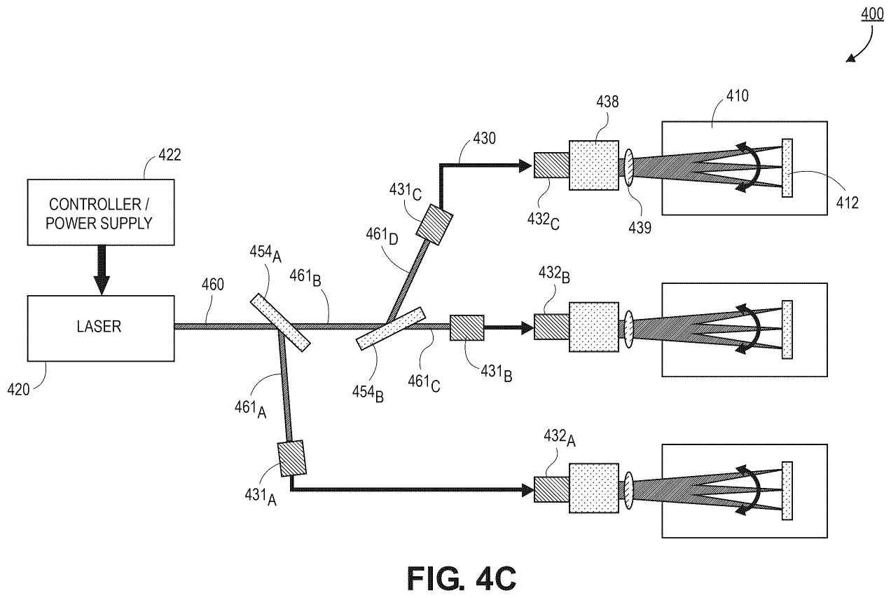

Referring now to FIGS. 4A-4C, a series of schematic illustrations of various tools 400 that use a single laser that is split into a plurality of channels for and used at different chambers to monitor a process or implement a process is shown, in accordance with an embodiment. FIG. 4A is an example of chamber monitoring using absorption spectroscopy, FIG. 4B is an example chamber monitoring using interferometry for endpoint detection of a process, and FIG. 4C is an example of chambers using split laser beams for processing (e.g., annealing).

Referring now to FIG. 4A, a schematic illustration of a tool 400 that includes a laser monitoring system that is capable of monitoring a gas species 408 within a plurality of chambers 410 is shown, in accordance with an embodiment. In an embodiment, the tool 400 may be similar to the tool 300 in FIG. 3D, with a more detailed explanation of the absorption spectroscopy process within each of the chambers 410.

In an embodiment, each of the chambers 410 may be optically coupled to the same laser 420 in order to implement laser-based sensing within the chamber 410 (e.g., similar to any of the laser-based sensing described in greater detail herein). In a particular embodiment, a ratio of a number of chambers 410 to a number of lasers 420 may be 2:1 or greater, 3:1 or greater, 4:1 or greater, or 10:1 or greater. In the particular embodiment shown in FIG. 4A, the ratio is 3:1.

In an embodiment, the chambers 410 may be similar to any of the chambers described in greater detail herein. For example, the chambers 410 may be sub-atmospheric pressure chambers 410 suitable for supporting a plasma. In the illustrated embodiment, the chambers 410 are shown as stand-alone chambers 410. Though, two or more of the chambers 410 may be coupled to a single cluster tool (e.g., similar to the embodiment shown in FIG. 2).

In an embodiment, the laser 420 may be an MIR laser or an FIR laser. The laser 420 may be similar to any of the lasers described in greater detail herein. The laser 420 may be coupled to supporting components 422, such as a controller, a power supply, a heatsink, and/or the like. In an embodiment, the laser 420 is configured to emit a primary beam 460. The laser 420 may be optically coupled to an optics module 450.

In an embodiment, a plurality of optical windows 454 are used to provide additional splitting of the primary beam 460 to provide additional channels 430 to support additional chambers 410. When multiple optical windows 454 are used, the angles need to be chosen in order to provide even intensity distribution between the different channels 430. For example, the first optical window 454_{A} may have a first angle θ₁ that produces a first split beam 461_{A} that has approximately 33% of the intensity of the primary beam 460, and a second split beam 461_{B} has approximately 67% of the intensity of the primary beam 460. In the case of an s-polarized primary beam 460 and a sapphire first optical window 454_{A} the first angle θ₁ may be about 52.5°.

In an embodiment, the second split beam 461_{B} continues to a second optical window 454_{B} that provides an additional split into a third split beam 461_{C} and a fourth split beam 461_{D}. The second optical window 454_{B} may provide an intensity split that provides the third split beam 461_{C} and the fourth split beam 461_{D} with about 33% of the intensity of the primary beam 460 (or about half of the intensity of the first split beam 461_{A}). In the case of an s-polarized primary beam 460 and a sapphire second optical window 454_{B} the second angle θ₂ may be about 63°.

Accordingly, the optics module 450 provides a three-way split of the primary beam 460. The first split beam 461_{A} may be optically coupled into an optical fiber of a channel 430 through a first fiber collimator 431_{A}, a third split beam 461_{C} may be optically coupled into an optical fiber of a channel 430 through a second fiber collimator 431_{B}, and a fourth split beam 461_{D} may be optically coupled into an optical fiber of a channel 430 through a third fiber collimator 431_{C}. As can be appreciated, the use of a plurality of optical mirrors in series and at different angles can be used to generate any number of channels 410 to accommodate a corresponding number of chambers 410.

As shown, each channel 430 may end with fiber collimators 432_{A}-432_{C}. In an embodiment, the first split beam 461_{A} is emitted out of a fourth fiber collimator 432_{A} and propagates through a chamber 410 to a detector 435, the third split beam 461_{C} is emitted out of a fifth fiber collimator 432_{B} and propagates through a chamber 410 to a detector 435, and the fourth split beam 461_{D} is emitted out of a sixth fiber collimator 432_{C} and propagates through a chamber 410 to a detector 435.

In an embodiment, the wavelength of the primary beam 460 and the corresponding split beams 461 may be chosen to be a wavelength that is absorbed by a particular species 408 present within the chambers 410. For example CO is absorbed well at about 4.6 μm. The decrease in the intensity of the split beams 461 detected by each detector 435 may be used to determine a concentration of the species 408 that is present within the corresponding chamber 410.

Referring now to FIG. 4B, a schematic illustration of a tool 400 that includes a laser monitoring system that is capable of implementing endpoint detection of the processing of substrates 412 within a plurality of chambers 410 is shown, in accordance with an embodiment. In an embodiment, the tool 400 may be similar to the tool 400 in FIG. 4A, with the exception of the monitoring process. For example, the detector 435 may be set up as an interferometer.

In an embodiment, the interferometer setup may result in the in the split beam 461 passing through an angled third optical window 454_{C} before propagating into the chamber 410. The split beam 461 may reflect off of the substrate 412 and reflect back to the third optical window 454_{C}. The third optical window 454_{C} diverts a portion of the split beam 461_{E} to the detector 435. A portion of the split beam 461 may also be diverted to a beam block 436. In an embodiment, the third angle θ₃ of the third optical window 454_{C} may be the same as the second angle θ₂. Though, any suitable value for the third angle θ₃ may be used to route the split beam to the desired locations at the desired intensities. In an embodiment, the partial transmission and reflection of the different layers that are added to (or removed from) the substrate 412 generates an interference signal at the detector 435 that can be used to determine when a desired change to the substrate 412 surface (e.g., adding a layer, removing a layer, changing a thickness of a layer, etc.) is completed.

Referring now to FIG. 4C, a schematic illustration of a tool 400 that includes a laser monitoring system that is capable of implementing endpoint detection of the processing of substrates 412 within a plurality of chambers 410 is shown, in accordance with an embodiment. In an embodiment, the tool 400 may be similar to the tool 400 in FIG. 4A, with the exception of the substitution of a detector 435 with a scanner 438. The scanner 438 may be a galvo scanner that is able to rotate the split beam 461 (as indicated by the curved double arrow) across the surface of the substrate 412. In some embodiments, a lens 439 may also be provided after the scanner 438 in order to focus the split beam 461.

In an embodiment, the scanned split beam 461 may be used to process the substrate 412 in some way. For example, the scanned split beam 461 may be used to heat the substrate 412. The heating may be used to anneal the substrate 412. Though, other processing may be controlled by a scanner 438. For example, laser writing of a pattern on the substrate 412 (e.g., for photolithography exposure) may be implemented by the scanner 438.

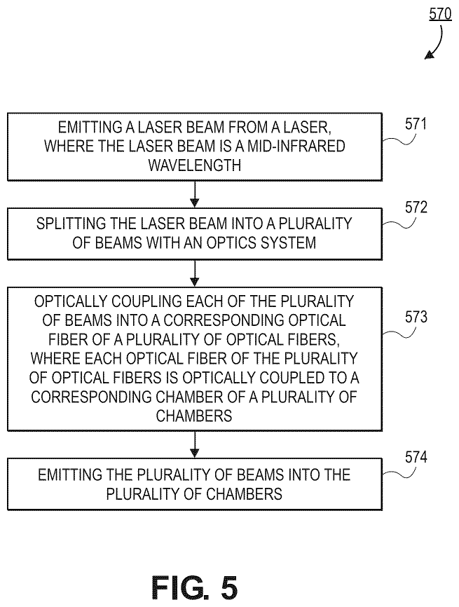

Referring now to FIG. 5, a flow diagram of a process 570 for implementing laser-based sensing in a plurality of chambers with the use of a single laser is shown, in accordance with an embodiment. In an embodiment, the process 570 may begin with operation 571, which comprises emitting a laser beam from a laser. In an embodiment, the laser beam has an MIR wavelength, a LIR wavelength, or any other suitable wavelength. In an embodiment, the laser beam may be polarized (e.g., s-polarized), or un-polarized.

In an embodiment, the process 570 may continue with operation 572, which comprises splitting the laser beam into a plurality of beams with an optics system. In an embodiment, the optics system may be similar to any of the optics modules described in greater detail herein. For example, the optics system may comprise one or more of a beam splitter, an optical window, a mirror, a retroreflector, a DOE, a lens, or the like. In an embodiment, the plurality of beams may each have a substantially equal intensity. Other embodiments may include one or more beams of the plurality of beams that have a different intensity.

In an embodiment, the process 570 may continue with operation 573, which comprises optically coupling each of the plurality of beams into a corresponding optical fiber of a plurality of optical fibers. In an embodiment, each optical fiber of the plurality of optical fibers is optically coupled to a corresponding chamber of a plurality of chambers. For example, ends of the optical fibers may comprise a fiber collimator to improve optical coupling efficiency between the optics system and the optical fibers. In an embodiment, one or more of the plurality of beams may be optically coupled to a reference cell (e.g., through an optical fiber or directly from the optics system through free space).

In an embodiment, the process 570 may continue with operation 574, which comprises emitting the plurality of beams into the plurality of chambers. In an embodiment, each beam may pass through an interior of the chamber and be detected by a detector after passing through the interior of the chamber. In an embodiment, an intensity of the beam detected by the detector may be used to monitor one or more properties (e.g., gas composition, plasma species composition, species concentration, and/or the like) through one or more sensing techniques (e.g., absorption spectroscopy or the like).

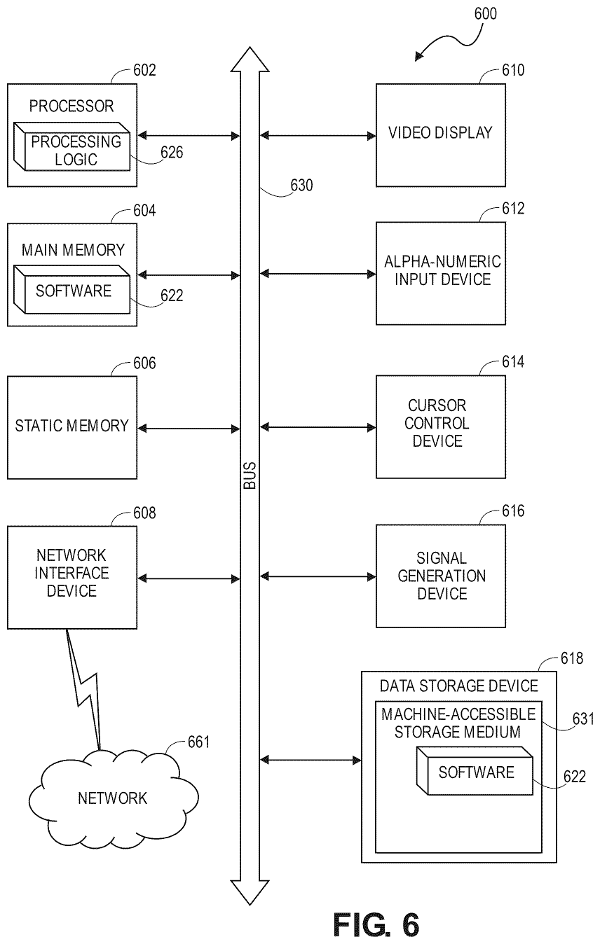

Referring now to FIG. 6, a block diagram of an exemplary computer system 600 of a processing tool is illustrated in accordance with an embodiment. In an embodiment, computer system 600 is coupled to and controls processing in the processing tool. Computer system 600 may be connected (e.g., networked) to other machines in a Local Area Network (LAN), an intranet, an extranet, or the Internet. Computer system 600 may operate in the capacity of a server or a client machine in a client-server network environment, or as a peer machine in a peer-to-peer (or distributed) network environment. Computer system 600 may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated for computer system 600, the term “machine” shall also be taken to include any collection of machines (e.g., computers) that individually or jointly execute a set (or multiple sets) of instructions to perform any one or more of the methodologies described herein.

Computer system 600 may include a computer program product, or software 622, having a non-transitory machine-readable medium having stored thereon instructions, which may be used to program computer system 600 (or other electronic devices) to perform a process according to embodiments. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., infrared signals, digital signals, etc.)), etc.

In an embodiment, computer system 600 includes a system processor 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a secondary memory 618 (e.g., a data storage device), which communicate with each other via a bus 630.

System processor 602 represents one or more general-purpose processing devices such as a microsystem processor, central processing unit, or the like. More particularly, the system processor may be a complex instruction set computing (CISC) microsystem processor, reduced instruction set computing (RISC) microsystem processor, very long instruction word (VLIW) microsystem processor, a system processor implementing other instruction sets, or system processors implementing a combination of instruction sets. System processor 602 may also be one or more special-purpose processing devices such as an application specific integrated circuit (ASIC), a field programmable gate array (FPGA), a digital signal system processor (DSP), network system processor, or the like. System processor 602 is configured to execute the processing logic 626 for performing the operations described herein.

The computer system 600 may further include a system network interface device 608 for communicating with other devices or machines. The computer system 600 may also include a video display unit 610 (e.g., a liquid crystal display (LCD), a light emitting diode display (LED), or a cathode ray tube (CRT)), an alphanumeric input device 612 (e.g., a keyboard), a cursor control device 614 (e.g., a mouse), and a signal generation device 616 (e.g., a speaker).

The secondary memory 618 may include a machine-accessible storage medium 631 (or more specifically a computer-readable storage medium) on which is stored one or more sets of instructions (e.g., software 622) embodying any one or more of the methodologies or functions described herein. The software 622 may also reside, completely or at least partially, within the main memory 604 and/or within the system processor 602 during execution thereof by the computer system 600, the main memory 604 and the system processor 602 also constituting machine-readable storage media. The software 622 may further be transmitted or received over a network 661 via the system network interface device 608. In an embodiment, the network interface device 608 may operate using RF coupling, optical coupling, acoustic coupling, or inductive coupling.

While the machine-accessible storage medium 631 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies. The term “machine-readable storage medium” shall accordingly be taken to include, but not be limited to, solid-state memories, and optical and magnetic media.

In the foregoing specification, specific exemplary embodiments have been described. It will be evident that various modifications may be made thereto without departing from the scope of the following claims. The specification and drawings are, accordingly, to be regarded in an illustrative sense rather than a restrictive sense.

What is claimed is:

1. An apparatus, comprising:
a laser configured to emit a laser beam;
an optics module optically coupled to the laser, wherein the optics module comprises an optical element configured to split the laser beam into a plurality of split beams; and
a plurality of optical fibers, wherein each of the plurality of optical fibers is configured to receive a corresponding one of the plurality of split beams.

2. The apparatus of claim 1, wherein the laser beam comprises a mid-infrared (MIR) wavelength or a far-infrared (FIR) wavelength.

3. The apparatus of claim 1, wherein the laser beam is polarized.

4. The apparatus of claim 1, wherein the optical element comprises a diffractive optical element.

5. The apparatus of claim 4, wherein the optics module further comprises a lens.

6. The apparatus of claim 1, wherein the optical element comprises a beam splitter.

7. The apparatus of claim 1, wherein the optical element comprises an optical window oriented at an angle with respect to the laser beam that is configured to split the laser beam into the plurality of split beams.

8. The apparatus of claim 1, wherein the plurality of optical fibers each comprise a fiber collimator configured to receive the corresponding one of the plurality of split beams.

9. The apparatus of claim 1, further comprising:
a reference cell, wherein one of the plurality of split beams is configured to pass through the reference cell; and
a detector configured to receive the one of the plurality of split beams after the one of the plurality of split beams passes through the reference cell.

10. The apparatus of claim 1, further comprising:
a plurality of chambers, wherein each of the plurality of chambers is optically coupled to a corresponding one of the plurality of optical fibers.

11. A tool, comprising:
a laser configured to emit a primary laser beam;
an optics module optically coupled to the laser, wherein the optics module comprises an optical element configured to split the primary laser beam into a plurality of split beams;
a substrate transfer chamber;
a plurality of processing chambers coupled to the substrate transfer chamber, wherein each processing chamber of the plurality of processing chambers comprises:
an optical fiber configured to receive one of the plurality of split beams, and wherein each of the plurality of split beams is configured to pass through an interior volume of a corresponding one of the plurality processing chambers; and
a detector for receiving the corresponding split beam of the plurality of split beams after the corresponding split beam passes through the interior volume of the corresponding one of the plurality of processing chambers.

12. The tool of claim 11, wherein the plurality of processing chambers comprises three or more processing chambers.

13. The tool of claim 11, wherein the optics module comprises one or more of a beam splitter, an optical window, a diffractive optical element, a mirror, or a retroreflector.

14. The tool of claim 11, wherein the plurality of split beams and the detectors are configured to monitor a processing condition within the plurality of chambers.

15. The tool of claim 14, wherein the processing condition is a gas concentration, and wherein the plurality of split beams and the detectors are configured to measure the gas concentration through absorption spectroscopy.

16. The tool of claim 14, wherein the processing condition is endpoint detection, and wherein the plurality of split beams and the detectors are configured to implement endpoint detection through interferometry.

17. An apparatus, comprising:
a laser configured to emit a primary beam, wherein the primary beam has a wavelength between 2 μm and 15 μm;
an optics module optically coupled to the laser, wherein the optics module comprises an optical element configured to split the primary beam into a plurality of split beams;
a plurality of optical fibers, wherein each of the plurality of optical fibers is optically coupled to the optics module so that each of the plurality of optical fibers is configured to receive a corresponding one of the plurality of split beams; and
a plurality of chambers, wherein each of the plurality of chambers is optically coupled to a corresponding one of the plurality of optical fibers.

18. The apparatus of claim 17, wherein the optics module comprises one or more of a beam splitter, an optical window, a diffractive optical element, a mirror, or a retroreflector.

19. The apparatus of claim 17, wherein the plurality of optical fibers comprises three or more optical fibers.

20. The apparatus of claim 17, further comprising:
a plurality of scanners, wherein each scanner is optically coupled to a different one of the plurality of chambers, and wherein the plurality of scanners are each configured to scan one of the plurality of split beams across one of a plurality of substrates, wherein each of the plurality of chambers houses one of the plurality of substrates.
